(19) United States
(12) Patent Application Publication
(10) Pub. No.: US 2013/0082037 A1
(43) Pub. Date: Apr. 4, 2013

(54) METHOD OF ABLATING A THREE-DIMENSIONAL SURFACE USING A LASER ABLATION DEVICE AND THROUGH THE USE OF A CALIBRATION STEP; DEVICE FOR IMPLEMENTING SUCH A METHOD

(71) Applicants: François Champonnois, Bures Sur Yvette (FR); Bertrand Laval, Paris (FR)

(72) Inventors: François Champonnois, Bures Sur Yvette (FR); Bertrand Laval, Paris (FR)

(21) Appl. No.: 13/518,363

(22) PCT Filed: Dec. 22, 2010
(86) PCT No.: PCT/EP10/70484

§ 371 Date: Dec. 18, 2012

(30) Foreign Application Priority Data
Dec. 22, 2009 (FR) 0959411

(51) Int. Cl. B23K 26/36

(52) U.S. Cl. CPC B23K 26/36
USPC 219/121.81

(57) ABSTRACT

The invention relates to a method characterized in that it comprises—a step (E1) of calibrating a device, whereby—a galvanometric head illuminates along two axes a calibration plate, situated at a depth, in order to illuminate a plurality of determined points of the calibration plate, while a camera observes said calibration plate, a control unit establishing a relationship between, on the one hand, the position of illumination of each of the illuminated points of the calibration plate at the depth, and, on the other hand, the position observed by the camera of the illuminated points; the calibration plate being successively positioned at a plurality of depths during the calibration step so as to allow a plurality of illuminations by the head, of observations by the camera and of relationships to he established by the control unit; the control unit establishes a correspondence relationship,—a step (E2) of determining the three-dimensional shape of the surface that is to be ablated, from the calibration step (E1), by triangulation, and—a step (ES) of ablating the three-dimensional surface whereby the control milt controls the galvanometric head as a function of the determined shape of the surface in order to focus and to direct, along axes that define a plane and to a depth, the beam onto the surface that is to be ablated. The invention also relates to a device for implementing an aforementioned method,

### GENERAL TECHNICAL FIELD

The present invention relates to a process for ablation of a three-dimensional surface by means of an ablation device, the device comprising:
a laser source for generating a pulsed laser beam;
a lens for varying the focal point of the laser beam according to a depth z;
a galvanometric head for directing, according to axes defining a plane (X, Y), the beam on the surface to be ablated;
an f-theta lens for displaying the laser beam on a plane surface instead of a spherical surface;
at least one observation camera of the surface to be ablated; and
a control unit connected at least to the galvanometric head, to the lens and to the camera.

The invention also relates to a device for executing the above process.

### PRIOR ART

As shown in FIG. 1, a solution known for effecting ablation of a surface 1, for example for the restoration of building facades or for decontamination of nuclear installations, consists of using laser ablation.

Laser ablation consists of removing a layer of reduced thickness of the material to be removed (dust, paint, or contaminant for example), via the interaction of light, coherent, focussed and originating from a pulsed laser, with this material.

Rapid heating of the surface of this layer causes vaporisation then ejection of the first strata of the material.

Known laser ablation devices 2 typically comprise a laser source 3 provided for generating a pulsed laser beam 4 and transport means of this beam to an optical module 6 located downstream of the laser source 3, and which is provided with a lens 5, a galvanometric head 7 and an f-theta lens 8 for focussing and directing according to the axes X and Y the pulsed beam onto the surface 1 to be ablated. The device also comprises 2 an outlet 13 and a discharge tube 12 for the evacuation of ablated materials.

At the output of the lens 5 and of the galvanometric head 7, the coordinates of the focal point are located on a spherical surface, which may complicate control of the beam. To overcome this difficulty the f-theta lens 8 is arranged on the path of the laser beam so as to locate the focal point on a plane surface.

This means contributing a sufficient quantity of energy to the layer for attaining the ablation threshold of the latter. Yet this is not the only effect made by a laser beam on the layer. In fact, at the moment of laser impact a shockwave is created and contributes to separating the material of the surface 1 to which it is applied.

FIG. 2 schematically illustrates the classic form of a beam 4.

The flow, or energy density (J/m²), necessary for triggering ablation of the material depends on the nature of the latter, the thickness to be ablated and the composition of the surface.

Tests show that a flow of 1 to 50 J/cm² is required. Consequently, the quantity of energy transmitted depends on the quantity of energy transported by the beam 4 and the section of this beam interacting with the material to be processed. The smallest section of the beam is located at the focussing distance L, a distance L at which the preferred point of ablation is located (see FIG. 1 also). It is of the order of 50 cm from the lens 8, for example.

As shown in FIG. 2, the beam 4 has a considerable depth I of field, corresponding to the Rayleigh distance, that is to say around 1 cm, for working on surfaces while freeing one self from planeity defects of the latter. The device is therefore well adapted for two-dimensional surfaces.

When the aim is to carry out ablation on a three-dimensional surface 1, as shown in FIG. 3, a variable-focus lens 5 must be linked to the laser source 3 to correct the focussing distance L.

As shown in FIG. 4 also, dynamically modifying the focussing distance L by means of a control unit 9 enables controlling the ablation distance on a three-dimensional surface 1.

The known preceding techniques have disadvantages, however.

The three-dimensional surface must be previously stored in the control unit 9 so it can be taken into account by the device.

It is not possible to perform ablation on a surface not known previously and determined previously by additional devices for determining the surface, such as theodolites for example, interferometers, conoscopic sensors, etc.

Also, additional devices for determining a three-dimensional surface of the prior art, necessary for prior determination of the surface, are expensive and bulky, and do not suit surface-ablation applications.

Finally, additional devices do not work in the same framework as the ablation device, which generates distortions, since the additional device does not have the same vision of the surface to be ablated as the ablation device, and can generate errors in positioning the laser beam.

US 2007/173792 discloses a technique for qualification and calibration of a laser system, according to which the laser system is qualified and/or calibrated as a function of deviation in a plane of a laser beam, relative to a preferred direction, observed by an imaging system.

US 2004/144760 discloses a calibrating technique of laser marking on a face opposite a face observed by an imaging system.

US 2009/220349 discloses a technique for triangulation of a three-dimensional surface by an imaging system also illuminating the surface, the system being distinct from a surface-ablation device.

### Presentation of the Invention

It is proposed to eliminate at least one of these disadvantages according to the invention.

For this purpose, an ablation process as claimed in Claim 1 is proposed according to the invention.

The invention is advantageously completed by the characteristics of Claims 2 to 9, taken singly or in any technically possible combination.

The invention also relates to a device for performing the above process.

The invention has numerous advantages.

The three-dimensional surface does not have to be previously known to be able to be taken into account by the control unit: the invention performs ablation on a surface not known previously.

Also, the invention does not require the use of additional devices for determining a three-dimensional surface. The invention utilises only those elements of the ablation device which consequently have the same framework and do not generate distortion.

Because of this, the device is less expensive and less bulky, which suits surface-ablation applications.

### PRESENTATION OF THE FIGURES

Other characteristics, aims and advantages of the invention will emerge from the following description which is purely illustrative and non-limiting and which must be considered with respect to the attached diagrams, in which:

FIG. 1, already commented on, schematically illustrates a known ablation device;

FIG. 2, already commented on, schematically illustrates a known ablation laser beam;

FIGS. 3 and 4, already commented on, schematically illustrate ablation of a three-dimensional surface;

FIG. 5 schematically illustrates the principal steps of a process according to the invention;

FIG. 6 schematically illustrates a possible example of a device for performing a process according to the invention;

FIG. 7 schematically illustrates the principle of triangulation;

FIG. 8 schematically illustrates determination of coordinates sx and sy in a reference plane of a head, by a control unit according to the invention;

FIG. 9 schematically illustrates determination of coordinates px and py in a reference plane of a matrix of a camera, by a control unit according to the invention;

FIG. 10 schematically illustrates the principal steps of a calibration step according to the invention;

FIG. 11 schematically illustrates a succession of plates viewed in plan view, with a transverse plate (in dotted lines) to show admissible tolerances;

FIG. 12 schematically illustrates correspondence curves of px as a function of sx, for different depths z;

FIG. 13 schematically illustrates respectively correspondence curves of a, b and c as a function of px;

FIG. 14 schematically illustrates a relation curve of z as a function of c;

FIGS. 15 and 16 schematically illustrate the principal steps of a step for determining the three-dimensional form of the surface to be ablated;

FIG. 17 schematically illustrates the principal alignment steps of the laser beam of the head 7 on the optical axis of the head;

FIG. 18 schematically illustrates the principal steps for orthogonality of the matrix relative to the plane (xOz);

FIG. 19 schematically illustrates an interpolation step by the control unit during the step for determining the three-dimensional form of the surface to be ablated;

FIG. 20 schematically illustrates a device comprising two cameras.

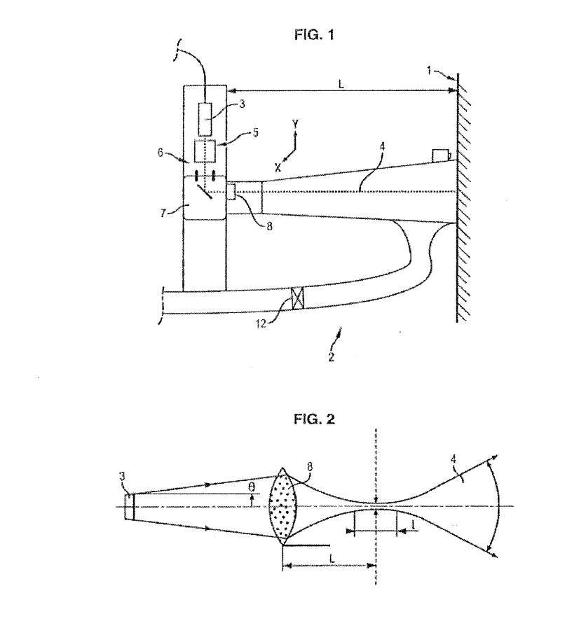

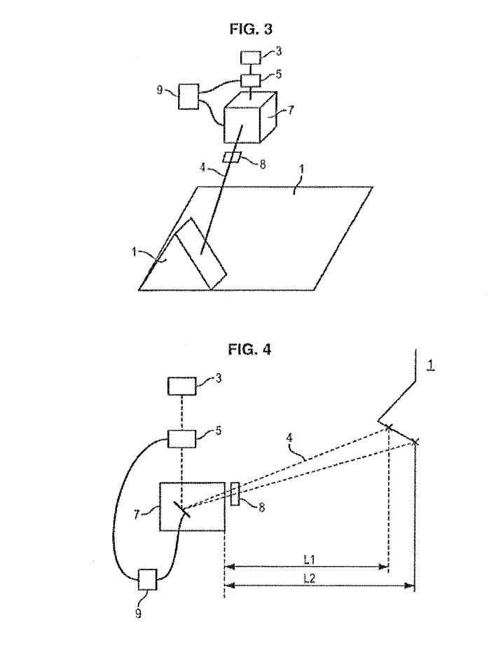

In all the figures similar elements bear identical reference numerals.

### DETAILED DESCRIPTION

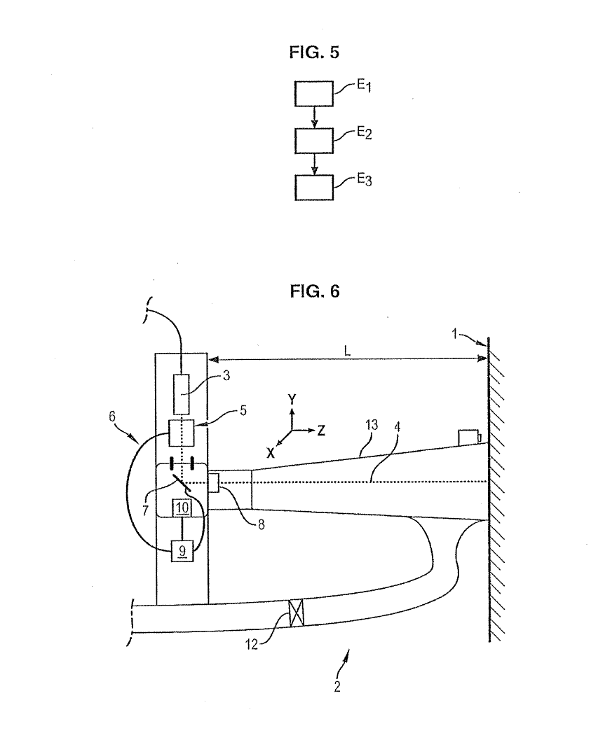

FIGS. 5 and 6 schematically illustrate the principal steps of an ablation process of a three-dimensional surface 1, performed on an ablation device 2.

The device 2 conventionally comprises:
a laser source 3 for generating a pulsed laser beam 4;
a lens 5 for adjusting the focal point of the laser beam 4 according to a depth z;
a galvanometric head 7 for directing, according to axes defining a plane (X, Y), the beam 4 on the surface 1 to be ablated;
an f-theta lens 8 which locates the focal point on a plane surface;
at least one observation camera 10 of the surface to be ablated.

The source 3 is for example a low-power pulsed fibre laser, (for example 20 W average power at a rate of 20 kHz, or 1 mJ by impulsion laser), with good beam quality (M²=1.5), signifying that the interaction beam/material section is sufficiently small to attain the above mentioned ablation flow. The point of impact has a diameter of 30 to 200 μm.

The lens 5, the head 7 and the lens 8 form an optical module referenced by 6 in FIG. 6. The lens 8 can also be independent of the module 6.

The head 7 conventionally comprises a set of two mirrors with motorised rotation. Each of these mirrors deviates the laser beam along the two axes X and Y with very rapid movement of the beam (up to 7 m/s at a focal distance of 160 mm).

The f-theta lens 8 is arranged downstream (in the direction of propagation of the laser beam) of the head 7 so as to locate the focal point of the laser beam on a plane surface. This f-theta lens 8 fixes the initial focal point of the laser beam in the absence of any command.

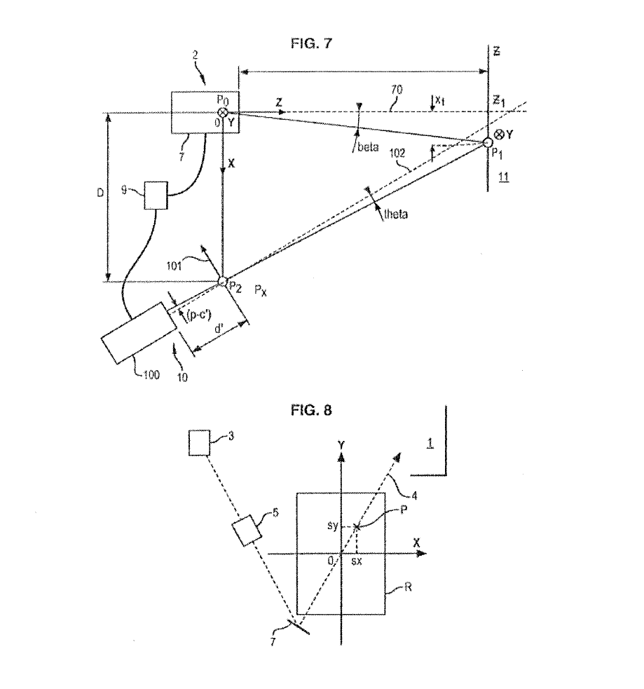

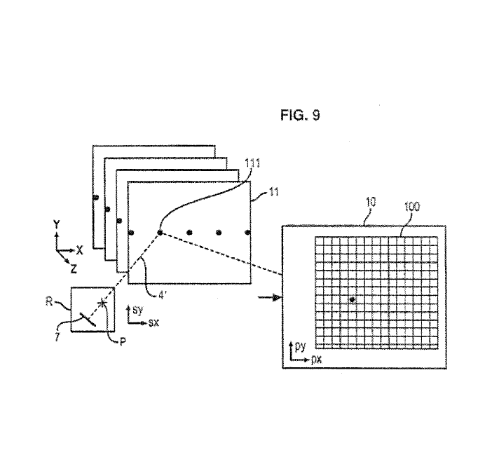

As shown in FIG. 7, the camera 10 is for example a low-definition camera comprising a matrix 100 of CCD type (512×512 with pixels of around 8 μm per side). This pixel size is largely sufficient for the preferred application: uncertainty of 1 pixel causes an error at the depth z of the surface 1 of the order of one hundredth of a mm. For a lens 101 of the camera 10 of 8 mm, the above uncertainty causes an angular error of the order of six one hundredths of a degree. For a lens 101 of 16 mm, the above measured angle error is of the order of three one hundredths of a degree.

The device 2 also comprises a control unit 9 attached on the one hand to the module 6, that is at least to the lens 5 and to the galvanometric head 7, and on the other hand to the camera 10. The lens 5 and the head 7 are fully controlled by the control unit 9. To this effect, the control unit 9 comprises all conventional memory, control unit and data-processing means.

FIG. 5 schematically shows that the process mainly comprises:
a calibration step E1 of the device 2,
a step E2 for determining the three-dimensional form of the surface 1 to be ablated, from the calibration step E1, by triangulation, and
an ablation step E3 of the three-dimensional surface, according to which the control unit 9 controls the module 6, specifically at least the lens 5 and the galvanometric head 7, as a function of the determined form of the surface, for focussing and directing according to axes defining a plane (X, Y) and according to a depth z the beam 4 on the surface 1 to be ablated.

The following developments show that calibration step E1 enables triangulation step E2.

As shown in FIG. 7, the device 2 utilises the principle of triangulation to measure the depth z of a point P1 to be processed on the surface 1 to be ablated.

By way of triangulation in the triangle (PO, P1, P2), knowing by construction the distance D between the camera 10 (P2) and the head 7 (PO), and by measuring the two angles beta and theta, the control unit 9 can return to the depth at z of the illuminated point P1 by means of the relationship known to the expert:

$$z = \frac{D}{\frac{1}{tan ( \frac{π}{2} - beta )} + \frac{1}{tan ( \frac{π}{4} + theta )}}$$

The matrix 100/lens 101 assembly enables measurement of the angle theta which the beam image of the illuminated point P1 makes with the optical axis 102 of the lens 101.

Knowing the distance of between the optical centre P2 (given that the lens 101 can be approximated on a thin lens) of the lens 101 and the centre c′ of the matrix 100 of the camera, as well as the distance (p-c′) separating the illuminated pixel p and the central pixel of the matrix the control unit 9 calculates the angle theta via the following trigonometry formula:

$$theta = arctan ( \frac{p - {c}^{′}}{{d}^{′}} ) .$$

By using the galvanometric head 7, the control unit 9 can return to the angle beta which the laser beam object with the optical axis 70 of the galvanometric head 7, by the following trigonometry formula:

$$beta = arctan ( \frac{x 1}{z 1} )$$

As shown on FIG. 7, in the same plane of depth focussing z, the points of a vertical line (according to the axis Y) have the same triangulation parameters (D, beta and theta) if and only if the two reference points of the triangulation P0 (head 7) and P2 (camera 10) are in the plane containing the optical axis of the head 7 (xOz). In the depth plane z, two points according to the axis Y are differentiated only by their respective coordinates on the axis Y, and P1 is the orthogonal projection of the point which the control unit wants to measure along the axis Y on the plane (xOz).

Therefore it is only the position according to the axis X of the sought-after point which will allow the control unit 9 to determine the depth z by triangulation.

In conclusion, if by construction of the device 2 the triangle (PO, P1, P2) is in the plane (xOz) (that is to say the camera 10 is correctly positioned relative to the head 7), the variations in the triangulation system caused by variation in position according to the axis Y of the measured point are eliminated.

Also, as shown by FIG. 8, the trajectory of the laser beam 4 passing through the galvanometric head 7 is completely defined by the two coordinates (sx, sy) of the point of intersection P of the beam 4 with a reference plane R of the head 7. The reference plane R of the head 7 is the plane orthogonal to the optical axis 70 in which all the points have their known coordinates of the head 7 (in a square the size of which is limited by the characteristics of the f-theta optical system 8).

Also, and as shown in FIG. 9, px is called the really observed position measured according to the axis X on the matrix 100, for example CCD, of the camera 10, and corresponding to the position x where it is located effectively on a plane 11 of focussing z which intercepts a laser beam 4′.

In reference to FIG. 7, a measured point is defined by D, beta and theta. The parameters which vary in the measuring system when the point P1 (orthogonal projection of the point measured on the plane (xOz)) moves are:
the coordinate sx according to the axis X of the point to be measured in the reference plane R of the galvanometric head 7;
the depth z of the focussing plane containing the point P1;
the coordinate px according to the axis X of the image of this point on the matrix 100 of the camera 10.

For a point of depth z there is one and one only couple (sx, px), and calibration step E1 consists for the control unit 9 of finding the correspondences which connect each point couple (sx, px) at z. Since the depth z is the magnitude which the control unit 9 aims to find, the control unit 9 must determine the relationship which, from sx, enables illumination of the point x of the object to be measured, and of the measurement px made by the camera 10 of the illuminated point, allows the control unit 9 to return to z.

So, for a focussing plane of known depth z, the control unit measures a plurality of couples of points (sx, px), and illustrates the curves px(sx) for different focussing planes with several z.

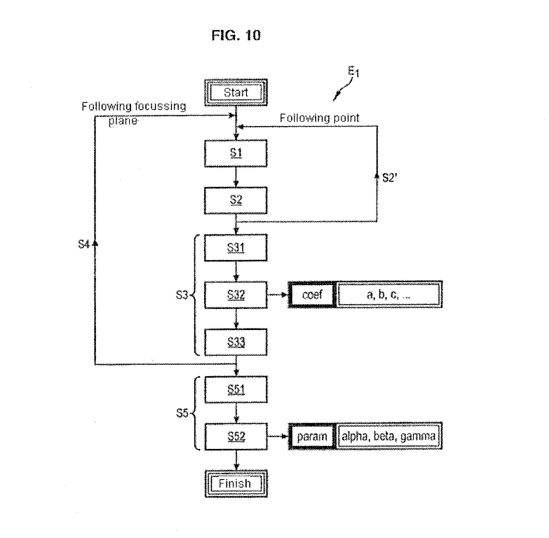

For this purpose, and as shown in FIG. 10 in combination with FIG. 9, calibration step E1 comprises a step S1 according to which the module 6, more precisely the galvanometric head 7, illuminates a point 111 of a calibration plate 11, located at a depth z, by means of a beam 4′. The coordinate sx is therefore known to the control unit 9, by means of the galvanometric head 7. This depth z must be known with precision better than the Rayleigh distance I, preferably under a tenth of this distance. In the same way, the parallelism error ε of this calibration plate 11 with the plane (xOy) must not exceed a tenth of the Rayleigh distance I, as shown in FIG. 11.

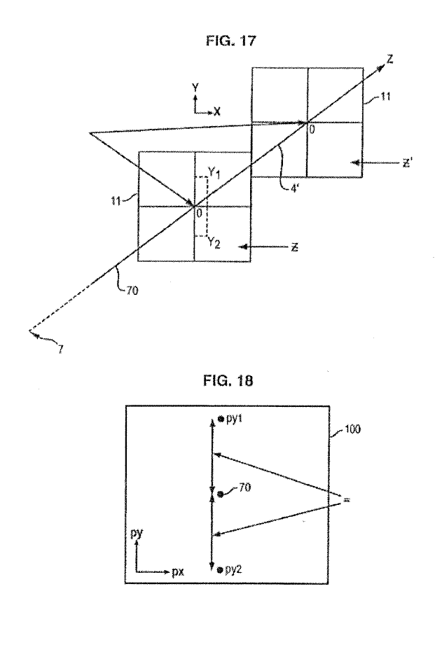

Under these conditions, the plates 11 must be sufficiently plane and sufficiently large to intercept the laser beam 4′ on the entire field reachable by the latter, irrespective of the depth z of the plate 11. The calibration plate 11 is illustrated schematically in FIGS. 11 and 17.

The beam 4′ is the laser ablation beam used at reduced power, or an auxiliary alignment beam (for example a HeNe laser) of the source 3, available, by construction, on the source 3, and colinear to the source 3. The power of the beam 4′ is reduced as it is not necessary to perform ablation of the calibration plate 11, but only illumination which can illuminate each point 111, such that each point 111 may be observed by the camera 10, as explained hereinbelow. During a step S2, the camera 10 observes said calibration plate 11 and the illuminated point 111. The control unit 9 then determines the coordinate px observed on the matrix 100 of the camera 10.

During a step S2, according to said axes X, Y the head 7 of the module 6 shifts the beam 4′ on the sight 11 for illuminating a plurality of determined points 111 of the calibration plate 11.

The determined plurality of points 111 of the calibration plate 11 is distributed according to continuous or dotted lines, and/or continuous or dotted columns.

When the number of points 111 is sufficient (of the order of 5 for example), the control unit moves to step S3,

During step S3, the control unit 9 sets up correspondence between:
on the one hand the illumination position sx of each of the illuminated points 111 of the calibration plate 11 at the depth z, and
on the other hand the position px observed by the camera 10 of the illuminated points.

For this purpose, the control unit 9 traces the curve during step S31 included in S3:

px=f(sx).

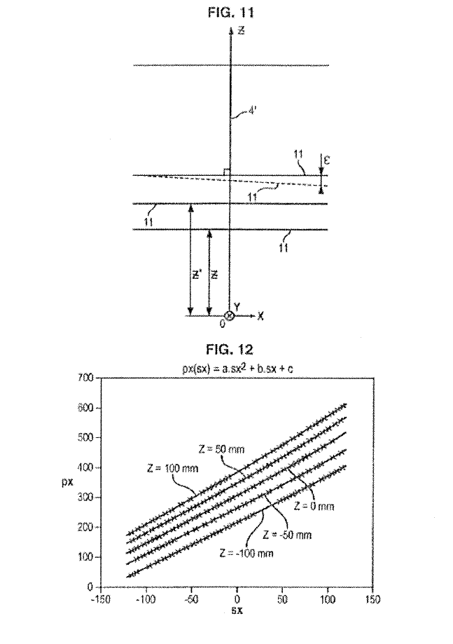

Examples of these curves are illustrated in FIG. 12 (curves with crosses). It is noticed that these curves can be approximated by a polynomial of the second degree.

During a step S32, from the curve of the step S31 the control unit 9 then determines the coefficients a, b and c linking px and sx in the form of a polynomial of the second degree such that:

px(sx)=α·sx²+b·sx+c (EQ1).

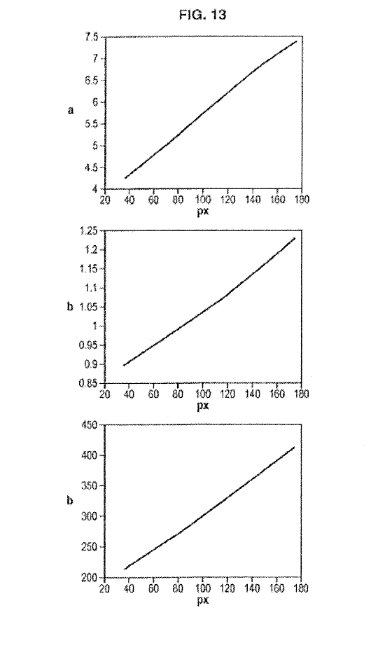

As shown on FIG. 13, this approximation is possible since a, b and c are substantially linear functions of sx.

During a step S33, the control unit 9 traces the corresponding curve (in full lines in FIG. 12).

During a step S4, steps S1, S2, S2′ and S3 described previously are repeated for another depth z and the calibration plate 11 is therefore placed at another depth z. Repeating steps S1, S2, S2′ and S3 allows a plurality of illuminations S1 by the module 6, a plurality of observations S2 by the camera 10 and a plurality of setting up correspondences S3 by the control unit 9.

The control unit 9 therefore has a network of curves as illustrated in FIG. 12, each curve corresponding to a given depth z.

When the number of depths z is sufficient (of the order of 5, for example), the control unit c moves to step S5.

A reminder that to trace one of the curves of FIG. 12, five couples of points (sx, px) for example are placed in correspondence, for each depth z of the calibration plate 11. The beam 4′ is for example projected in (coordinates in sx in mm):
−120, −60, 0, 60 and 120,
   on each of the depths z of the calibration plate 11.

In the same way, measurements are taken for five depths z, specifically for example (coordinates in z en mm, measured by means of a graduated rule, for example):
−100, −50, 0, 50 and 100.

The coordinate focussing plane at z 0 mm is the reference plane of the galvanometric head 7.

During a step S5, the control unit 9 determines a relationship between the correspondences.

For this purpose, during step S51 included in step S5 the control unit 9 traces the curve:

z=g(c).

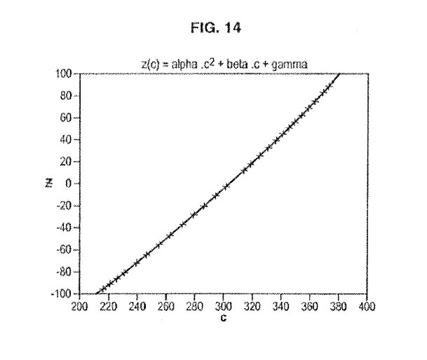

An example of such a curve is illustrated in FIG. 14 (curve with crosses).

It is noted that this curve can be approximated by a polynomial of the second degree.

During a step S52, the control unit determines the parameters α, β and γ linking all the couples z and c determined previously in the form of a polynomial of the second degree such that:

z(c)=α·c³+β·c+γ (EQ2).

The control unit 9 can therefore trace the corresponding curve (in solid lines in FIG. 14).

Calibration step E1 is terminated by means of the calibration plate 11.

In reference to FIG. 5, the process also comprises a step E2 for determining the three-dimensional form of the surface 1 to be ablated by triangulation from calibration step E1.

The following developments concern step E2.

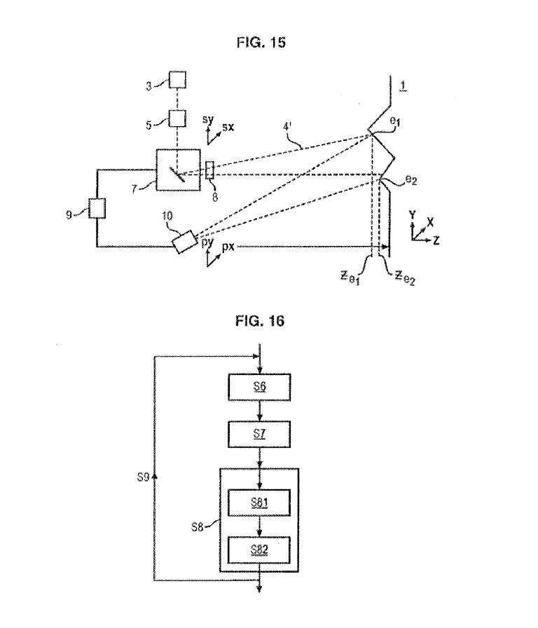

In reference to FIGS. 15 and 16, for step E2 for determining the three-dimensional form of the surface 1, the galvanometric head 7, that is, the module 6, illuminates during step S6 a point e of the surface 1 to be ablated. Illumination is effected the same way as for step E1, by a beam 4′ of reduced power.

During step S6, the control unit 9 therefore determines the coordinate sxe according to the axis X, by means of the galvanometric head 7.

During a step S7, the camera 10 observes the surface 1.

The control unit 9 then determines the coordinate pxe observed on the matrix 100 of the camera 10.

During a step S8, the control unit 9 determines the three-dimensional form of the surface 1 by means of the correspondences set up by the control unit 9 during calibration step E1.

So, during step S81, included in step 38, the control unit 9 determines the value ce by means of the values pxe and sxe by the formula:

ce=pse−α+sxe³−b·sxe (EQ3)

by using the coefficients a and b determined by the control unit 9 during calibration step E1.

The coefficient a and b are selected by the control unit 9 as indicated hereinbelow.

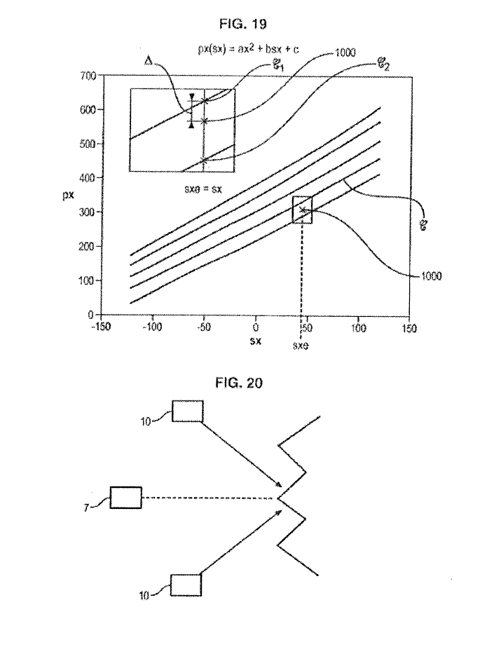

As shown in FIG. 19, on completion of step S4 of step E1, the control unit 9 has a network of curves C illustrated in solid lines in FIG. 19. Each curve C corresponds to the different values of coefficients a, b and c.

Yet, during steps S6 and S7 of E2, the control unit 9 determines sxe and pxe (illustrated by a cross 1000 in FIG. 19).

To select the good values of a and b in (EQ3), the control unit 9 performs interpolation Δ.

The control unit 9 calculates and stores the coordinate px of the points belonging to the curves C of the calibration network of FIG. 19 and having their coordinate sx identical to that of sxe of the sought-after point. Secondly, via a series of successive tests the control unit 9 will determine the curve C1 of the calibration network located just above the point to be measured. If there is no curve above this point, the control unit 9 takes the curve C2 located just below. Finally the control unit 9 utilises the relationship (EQ3) corresponding to the determined curve, with the corresponding values of a and b.

Also, during step S82, also included in step S8, the control unit 9 determines the depth ze by the formula:

ze=α·ce³+β·ce+γ (EQ4)

by using the parameters α, β and γ determined by the control unit 9 during calibration step E1.

As shown in FIG. 15, for each point e1 illuminated by the beam 4′ on the surface 1 the control unit 9 can determine the associated depth ze1.

As indicated by step S9 of FIG. 16, steps S6. S7 and S8 described previously are repeated for as many points of the surface as wanted, as a function of the preferred precision for determining the surface 1. The maximal spread according to the axes X and Y between two successive measuring points depends on the Rayleigh distance of the laser beam used and on the maximal variation according to the depth z observed on the surface 1 to be ablated.

FIG. 15 illustrates only two examples e1 and e2, for ze1 and ze2. The control unit 9 determines the three-dimensional form of the surface 1 by means of the correspondences set up by the control unit 9 during the calibration step.

Step E2 for determining the three-dimensional form of the surface 1 to be ablated is therefore terminated.

In reference to FIG. 5, the process also comprises an ablation step E3 of the three-dimensional surface, according to which the control unit 9 controls the module 6 as a function of the determined form of the surface, for focussing and directing, according to axes defining a plane (X, Y) and according to a depth z, the beam 4 on the surface 1 to be ablated.

This touches on ablation as known to the expert, and this step is no longer detailed throughout the present description.

However, for ablation step E3 the control unit 9 advantageously controls the module 6 for focussing and directing the beam 4 onto all the points of the surface 1 to be ablated, according to successive depths z. In this way, the control unit 9 controls the module 6 a lesser number of times and can therefore gain time for ablation. The control unit 9 controls the module 6 such that all the points to be calibrated located at the same depth z are processed prior to processing the points of the surface 1 located at another depth.

As shown in FIG. 20, the device advantageously comprises two cameras 10, which gives better knowledge of the surface 1 to be ablated, and if needed giving better ablation if the beam 4 can access the zones observed by the cameras (ablation of zones not observed in the case of a single camera).

The following developments concern adjustments to be made for better precision for calibration step E1 of the device 2.

The head 7 and the camera 10 must be in the same plane (xOz) (see FIG. 7). The calibration plate 11 must be parallel to the plane (xOy) with maximal admissible tolerance less than the Rayleigh distance I of the laser beam used, preferably better than a tenth of this distance. If, however, such tolerance were exceeded, the control unit 9 could perform correction of the position observed px by the camera 10 of the illuminated points to compensate the effects of distortion.

The head 7 is parameterised such that it points the laser beam to the centre of its reference plane R to define its optical axis 70. The beam of the head 7 must be in a plane (xOz). A simple actuator known to the expert shifts the reference calibration plate 11 along the optical axis of the head. As shown in FIG. 17, the laser beam 4′ of the head 7 is aligned with the optical axis 70 if it intersects the two planes z and z′ at the same point O.

Once the optical axis 70 is in the plane (xOz), the points P0 and P1 being located on the axis 70, with the parameterising hereinabove (point P1 is the intersection of the optical axis 70 with the calibration plate 11), the two points P0 and P1 are therefore located in the same plane (xOz).

Also, the centre of the matrix 100 and the centre P2 of the lens 101 are substantially placed on the same straight line as P1. The triangle defined by points (P0, P1, P2) is now placed in the same plane (xOz).

To ensure that the matrix 100 is orthogonal to the plane (xOz), and as shown in FIGS. 17 and 18, the head 7 illuminates a given point of coordinate y1 according to the axis Y on the calibration plate 11. By way of image processing, the control unit 9 measures the pixelic coordinate py1 according to the axis Y of the point image on the matrix 100 of the camera 10. Still on the calibration plate 11 at the same depth z, the head 7 illuminates a second point of same coordinate at x, but coordinate y2 opposite the preceding one at y. In the same way, the control unit 9 measures the pixelic coordinate py2 at y on the matrix 100. If this coordinate is the opposite to that of the first point relative to the central point of the 100, then the matrix 100 is orthogonal to the plane (xOz).

1. A process for ablation of a three-dimensional surface (1) by means of an ablation device (2), the device (2) comprising:
a laser source (3) for generating a pulsed laser beam (4);
an optical module (6) for focussing and directing, according to axes defining a plane (X, Y) and according to a depth (z), the beam (4) on the surface (1) to be ablated;
at least one observation camera (10) of the surface to be ablated; and
a control unit (9) attached to the module (6) and to the camera (10);
the process being characterised in that it comprises
a calibration step (El) of the device (2) according to which the module (6) illuminates (S1, S2′) according to said axes (X, Y) a calibration plate (11), located at a depth (z), for illuminating a plurality of determined points (111) of the calibration plate (11), whereas the camera (10) observes (S2) said calibration plate (11), the control unit (9) establishing (S3) a correspondence between on the one hand the illumination position (sx) of each of the illuminated points (111) of the calibration plate (11) at the depth (z) and on the other hand the position observed (px) by the camera (10) of the illuminated points;
the calibration plate (11) being successively positioned (S4) at a plurality of depths (z) during the calibration step to allow a plurality of illuminations (S1) by the module (6), observations (S2) by the camera (10) and setting up correspondences (S3) by the control unit (9);
the control unit (9) sets up (S5) a relationship between the correspondences,
a step (E2) for determining the three-dimensional form of the surface (1) to be ablated, from the calibration step (E1), by triangulation, and
an ablation step (E3) of the three-dimensional surface, according to which the control unit (9) controls the module (6) as a function of the determined form of the surface, for focussing and directing the beam (4) on the surface (1) to be ablated, according to axes defining a plane (X, Y) and according to a depth (z).

2. The process as claimed in claim 1, in which, for setting up, for each depth z, the correspondence between
on the one hand the illumination position sx of each of the illuminated points (111) of the calibration plate (11) at said depth z, and
on the other hand the position observed px by the camera (10), during calibration step (E1), the control unit (9) determines (S3) the coefficients a, b and c linking px and sx in the form of a polynomial of the second degree such that:
px(sx)=α·sx³+b·sc+c (EQ1).
and the control unit (9) determines (S5) also the parameters α, β and γ linking all the couples z and c determined previously in the form of a polynomial of the second degree such that:
z(c)=α·c³+β·c+γ (EQ2).

3. The process as claimed in claim 2, in which, for the calibration step (E1), the plurality of determined points (111) of the calibration plate (11) are distributed according to continuous or dotted lines, and/or continuous or dotted columns.

4. The process as claimed in any one of claim 2 or 3, in which at least five couples (sx, px) are placed in correspondence for each depth z of the calibration plate (11), for calibration, the calibration plate (11) being placed at least at five different depths (z).

5. The process as claimed in any one of claims 1 to 4, in which the control unit (9) executes a correction of the position observed (px) by the camera (10) of the illuminated points to compensate the effects of distortion.

6. The process as claimed in any one of claims 1 to 5, in which, for step (E2) for determining the three-dimensional form of the surface (1), the module (6) illuminates (S6) according to said axes (X, Y) the surface (1) to be ablated for illuminating a plurality of determined points (sxe) of the surface (1), whereas the camera (10) observes (S7) the surface (1) and also the illuminated points (pxe), the control unit (9) determining (S8) the three-dimensional form of the surface (1) by means of the correspondences and the relation set up by the control unit (9) during the calibration step.

7. The process as claimed in any one of claims 2 to 6, in which, for step (E2) for determining the three-dimensional form of the surface (1), from the position pxe observed on the camera (10) of the illuminated points sxe by the module (6), the control unit (9) determines (S81) the value ce by means of the values pxe and sxe by the formula:
ce×pse−α·sxc³−b·sxc (EQ3)
by using the coefficients a and b determined by the control unit (9) during the calibration step (E1),
then determines (582) the depth ze via the formula:
ze=α·ce²+β·ce+γ (EQ4)
by using the parameters α, β and γ determined by the control unit (9) during the calibration step (E1).

8. The process as claimed in claim 6, in which the control unit (9) completes interpolation of pxe and sxe by means of the coefficients a and b determined during calibration step (E1).

9. The process as claimed in any one of claims 1 to 8, in which, for ablation step (E3), the control unit (9) controls the module (6) for focussing and directing the beam (4) onto the surface (1) to be ablated according to successive depths (z).

10. A device (2) comprising:
a laser source (3) for generating a pulsed laser beam (4);
an optical module (6) for focussing and directing, according to axes defining a plane (X, Y) and according to a depth (Z), the beam (4) on the surface (1) to be ablated;
at least one observation camera (10) of the surface to be ablated;
said device (2) being characterised in that it also comprises a control unit (9) attached to the module (6) and to the camera (10), and adapted for executing a process as claimed in any one of claims 1 to 9.
